(19) United States
(12) Patent Application Publication
(10) Pub. No.: US 2017/0172144 A1
(43) Pub. Date: Jun. 22, 2017

(54) ECTOPARASITE FORMULATION

(71) Applicants: Douglas Robert Cleverly, Auckland (NZ); David Anthony Gill, Auckland (NZ); Desmond Ian John Morrow, Auckland (NZ)

(72) Inventors: Douglas Robert Cleverly, Auckland (NZ); David Anthony Gill, Auckland (NZ); Desmond Ian John Morrow, Auckland (NZ)

(21) Appl. No.: 15/116,804

(22) PCT Filed: Feb. 4, 2015
(86) PCT No.: PCT/IB2015/050857

§ 371 Date: Aug. 4, 2016

Related U.S. Application Data
(60) Provisional application No. 61/935,835, filed on Feb. 4, 2014.

(51) Int. Cl. A01N 25/14; A01N 25/04; A01N 43/90; A01N 47/18; A01N 43/22; A01N 25/24

(52) U.S. Cl. CPC A01N 25/14; A01N 43/22; A01N 25/24; A01N 43/90; A01N 47/18; A01N 25/04

(57) ABSTRACT

The present invention relates to a granule comprising one or more veterinary agents, the granule producing a formulation comprising an effective amount of the one or more veterinary agents and having a viscosity of less than about 250 to about 1,400 cps when the granule is mixed with an aqueous carrier, and/or the granule producing an aqueous formulation that dries to a film or gel and when applied transdermally substantially limits transdermal penetration of the one or more veterinary agents and/or substantially limits the loss of the one or more veterinary agents upon application of water to the animal, such as by rain.

### INCORPORATION BY REFERENCE

All documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. More specifically, all referenced documents are incorporated by reference to the same extent as if each individual document was specifically and individually indicated to be incorporated by reference.

### TECHNICAL FIELD

The present invention generally relates to dispersible granules comprising one or more therapeutic agents.

### BACKGROUND OF THE INVENTION

Existing formulations for the application of topically active therapeutic agents, such as ectoparaticides and insecticides, to sheep and cattle are known.

However, industry is faced with emerging resistance to such therapeutic agents. For example, resistance is very common for synthetic pyrethroids and common, depending on the active, for insect growth regulators. There is emerging resistance to cyromazine in blowfly, low-level cross-resistance to dicyclanil.

Additionally, some families of actives that are presently effective, such as organophosphates, may be banned owing to their toxicity.

There remains a need for new formulations for applying therapeutic agents.

It is an object of the present invention to go some way towards meeting this need; and/or to at least provide the public with a useful choice.

Other objects of the invention may become apparent from the following description which is given by way of example only.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date.

### SUMMARY OF THE INVENTION

In one broad aspect, the present invention relates to a granule comprising one or more veterinary agents, the granule when mixed with an aqueous carrier producing an aqueous formulation comprising an effective amount of the one or more veterinary agents and having a viscosity of less than about 250 to about 1,400 cps when the granule is mixed with an aqueous carrier, and/or wherein the aqueous formulation substantially limits transdermal penetration of the one or more veterinary agents when the formulation is administered topically.

In one broad aspect, the present invention relates to a granule comprising one or more veterinary agents, a wetting agent, a suspending agent and a bio-adhesive,

the granule when mixed with an aqueous carrier producing an aqueous formulation comprising an effective amount of the one or more veterinary agents and having a viscosity of less than about 250 to about 1400 cps,

wherein the aqueous formulation when topically applied to an animal dries to a film or gel substantially limiting the loss of the one or more veterinary agents upon application of water.

In one aspect, the invention relates to a granule comprising one or more veterinary agents, a wetting agent, a suspending agent and a bio-adhesive, the granule having a mean particle diameter of about 100 to about 1000 μm and a bulk density of about 0.250 to about 0.700 g/cm³.

In one aspect, the invention relates to a granule comprising
about 0.01 to about 65% by weight of one or more beneficial agents,
about 0.05 to about 5% by weight of a wetting agent,
about 0.01 to about 20% by weight of a suspending agent, and
about 0.1 to about 10% of a bio-adhesive.

In one aspect, the invention relates to a granule comprising
about 5 to about 55% by weight of one or more beneficial agents,
about 0.1 to about 3% by weight of a wetting agent,
about 1 to about 12% by weight of a suspending agent, and
about 0.1 to about 5% of a bio-adhesive.

In a further aspect the invention relates to a method of topically delivering a beneficial agent to an animal comprising
providing a granule that comprises the beneficial agent, a wetting agent, a suspending agent and a bio-adhesive,
forming an aqueous composition by suspending or dissolving the granule in an aqueous carrier, the aqueous composition having a viscosity of less than about 250 to about 1,400 cps,
administering the aqueous composition topically to an animal.

In a further aspect the invention relates to method of manufacturing a granule, comprising

forming a solids mixture on a fluid bed by mixing a wetting agent and a film former,

spraying a first spray composition comprising a dispersing agent onto the fluid bed and granulating this mixture,

optionally spraying a second spray composition comprising water onto the fluid bed and further granulating this mixture,

thereby providing the granule composition,

wherein at least one beneficial agent can be incorporated as
(i) an at least water soluble beneficial agent mixed with the solids mixture,
(ii) an at least water insoluble beneficial agent mixed with the first spray composition, or
(iii) both i) and ii).

In a further aspect there is a method of manufacturing a granule composition which comprises
mixing a first composition which comprises at least one beneficial agent that is substantially soluble in water, with a suspending agent, or
mixing a second composition which comprises at least one beneficial agent that is substantially insoluble in water with an inorganic solvent, and a wetting agent,
providing the first composition on a fluidised bed,
adding the second composition to the solids on the fluidised bed and granulating said mixture,
thereby providing the granule composition.

In one embodiment the granule has a mean particle diameter of about 100 to about 1000 μm.

In one embodiment the granule a bulk density of about 0.250 to about 0.700 g/cm³.

In one embodiment, the formulation comprises two or more veterinary agents.

In one embodiment, the therapeutic agent is selected from the group consisting of insecticides. In one embodiment, the insecticide is an ectoparasiticide.

In one embodiment, the ectoparasiticide is selected from the group consisting of:
pyrimidines (e.g. dicyclinil),
triazines (e.g. cyromazine),
pyrethroids (e.g. cypermethrin, deltamethrin),
spinosyns (e.g. spinosad),
neonicotinoids (e.g. imidacloprid),
organophosphates (including organothiophosphates, e.g. diazinon),
benzoylureas (e.g. diflubenzuron, fluazuron),
macrolides (e.g. ivermectin), and
amidines (e.g. amitraz).

In one embodiment, the formulation comprises two or more ectoparasiticides.

In one embodiment the granule comprises a pyrimidine-derived regulator of insect growth in combination with a second active selected from the group comprising
(i) a spinosyn,
(ii) a neonicotinoid,
(iii) a benzamide,
(iv) a benzoylurea, and
(v) any combination of (i) to (iv).

In one embodiment the granule comprises a pyrimidine-derived regulator of insect growth in combination with a second active selected from the group comprising
(i) spinosad,
(ii) imidacloprid,
(iii) diflubenzuron,
(iv) triflumuron, and
(v) any combination of (i) to (iv).

In one embodiment the pyrimidine-derived regulator of insect growth is dicyclanil.

In one embodiment the spinosyn is selected from the group comprising spinosad and spinetoram.

In one embodiment the neonicotinoid is selected from the group comprising imidacloprid, thiacloprid, dinotefuxan, clothianidin and nitenpyram.

In one embodiment the benzamide is diflubenzuron.

In one embodiment the benzoylurea is triflumuron.

In one embodiment the granule comprises a triazine in combination with a second active selected from the group comprising
(i) spinosyn,
(ii) a neonicotinoid, and
(iii) a combination of (i) and (ii).

In one embodiment the granule comprises a triazine in combination with a second active selected from the group comprising
(i) spinosad,
(ii) imidacloprid, and
(iii) a combination of (i) and (ii).

In one embodiment the triazine is cyromazine.

In one embodiment the spinosyn is spinosad or spinetoram.

In one embodiment the neonicotinoid is selected from the group comprising imidacloprid, thiacloprid, dinotefuxan, clothianidin and nitenpyram.

In one embodiment the granule comprises a pyrethroid insecticide in combination with a second active selected from the group comprising
(i) a benzamide,
(ii) a macrocyclic lactone,
(iii) an amidine, and
(iv) a combination of (i) and (ii).

In one embodiment the granule comprises a pyrethroid insecticide in combination with a second active selected from the group comprising
(i) diflubenzuron,
(ii) ivermectin,
(iii) amitraz, and
(iv) a combination of (i) and (ii).

In one embodiment the pyrethroid insecticide is cypermethrin. In another embodiment the pyrethroid insecticide is deltamethrin.

In one embodiment the benzamide is diflubenzuron. In another embodiment the benzamide is fluazuron.

In one embodiment the macrocyclic lactone is ivermectin.

In one embodiment the amidine is amitraz.

In one embodiment, the granules comprise one or more disintegrants, surfactants, or dispersants.

In one embodiment, the granule on dispersion in the aqueous carrier provides a homogeneous liquid formulation.

In one embodiment, the granule disperses in the aqueous carrier to form an acceptable homogenous formulation within 10, 15, 20, 25, 30, 35, 40, 45, 50, 55 or 60 seconds, and useful ranges may be selected between any of these values.

In one embodiment the aqueous carrier is water.

In one embodiment, the liquid formulation is thixotropic.

In one embodiment, the liquid formulation is a concentrate that is diluted prior to application.

In another aspect, the present invention provides an aqueous liquid formulation comprising one or more topically active therapeutic agents.

In some embodiments the granule, once suspended in an aqueous carrier, forms a stable film or gel when applied to an animal's skin, wool, hair, or combination thereof.

In one embodiment the film or gel is effective at resisting loss of active agent during a rainfall event.

In one embodiment the film or gel looses less than 50, 45, 40, 35, 30, 25, 20, 15, 10 mg of active agent per 100 mL of water following a simulated rain event.

In one embodiment, the liquid formulation is suitable for application to an animal. In one embodiment, the liquid formulation is suitable for topical application to an animal.

In one embodiment, the liquid formulation on application forms a film or gel comprising the one or more veterinary agents. In one embodiment, the film or gel provides sustained release of the one or more therapeutic agents over a prolonged period of time.

In one embodiment the film or gel is an adhesive film or an adhesive gel.

In one embodiment less than about 50, 45, 40, 35, 30, 25, 20, 15, or 10% by weight of the veterinary agent is lost when the film or gel is contacted with 100 mL of water applied over 5, 10, 15, or 20 min, and useful ranges may be selected between any of these values. In various embodiments the amount of film or gel contacted with water is about 5, 6, 7, 8, 9, 10 g.

In one embodiment less than 50, 45, 40, 35, 30, 25, 20, 15, 10 mg of the veterinary agent is lost per 100 mL of water following a simulated rain event, and useful ranges may be selected between any of these values.

In one embodiment the active agent loss from the film or gel after a simulated rain event is less than 1, 2, 3, 4, 5, 6, 7, 8, 9, 10 mg/mL, and useful ranges may be selected between any of these values.

In one embodiment, the animal is a mammal. In one embodiment, the mammal is a non-human mammal. In one embodiment, the non-human mammal includes farmed or unfarmed animals, domestic or companion animals (e.g. cattle, sheep, horses, deer, swine, dogs, cats, etc).

In another aspect, the present invention provides a method of treating an animal, the method comprising topically administering an effective amount of an aqueous liquid formulation of the present invention to an animal in need thereof.

In one embodiment, the method is for treating an ectoparasite or insect infestation or infection.

In another broad aspect, the present invention provides a method of preparing a granular formulation of the present invention.

In a further aspect the invention relates to a rapidly dispersing granule containing at least one beneficial agents, such as a parasiticides and/or insecticides, wherein once dissolved in a diluent (such as water), the formulation has the ability to dry on the skin/hair of the animal leaving a bioadhesive film to prolong the action of the beneficial agents on the target mammal, while substantially limiting transdermal penetration of the one or more veterinary agents.

In one embodiment less than 1, 0.9, 0.8, 0.7, 0.6, 0.5, 0.4, 0.3, 0.2 or 0.1% by weight of the active agent penetrates the dermis, and useful ranges may be selected between any of these values.

In one embodiment the granule is formulated to provide, when mixed with an aqueous carrier, an aqueous formulation that when administered topically limits transdermal penetration of the one or more veterinary agents, such that less than 1% of the one or more veterinary agents present in the aqueous formulation prior to administration penetrates the dermis.

In one embodiment the granule is formulated to provide, when mixed with an aqueous carrier, an aqueous formulation that when administered topically limits transdermal penetration of the one or more veterinary agents, such that less than 0.1% of the one or more veterinary agents present in the aqueous formulation prior to administration penetrates the dermis.

In one embodiment the granule is formulated to provide, when mixed with an aqueous carrier, an aqueous formulation that when administered topically to an animal dries to a film or gel, wherein the film or gel substantially limits the loss of the one or more veterinary agents upon application of water such that less than 10% of the one or more veterinary agents present in the aqueous formulation prior to administration is lost.

The granule of claim 35, wherein the granule is formulated to provide when mixed with an aqueous carrier an aqueous formulation that when administered topically to an animal dries to a film or gel, wherein the film or gel substantially limits the loss of the one or more veterinary agents upon application of water such that less than 5% of the one or more veterinary agents present in the aqueous formulation prior to administration is lost.

The granule of claim 36, wherein the granule is formulated to provide when mixed with an aqueous carrier an aqueous formulation that when administered topically to an animal dries to a film or gel, wherein the film or gel substantially limits the loss of the one or more veterinary agents upon application of water such that less than 1% of the one or more veterinary agents present in the aqueous formulation prior to administration is lost.

As used herein “(s)” following a noun means the plural and/or singular forms of the noun.

As used herein the term “and/or” means “and” or “or” or both.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In one embodiment the invention relates to the manufacture of a granule of the present invention as described.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

Although the present invention is broadly as defined above, those persons skilled in the art will appreciate that the invention is not limited thereto and that the invention also includes embodiments of which the following description gives examples.

Accordingly, it is an object of the invention to not encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. §112, first paragraph) or the EPO (Article 83 of the EPC), such that Applicants reserve the right and hereby disclose a disclaimer of any previously described product, process of making the product, or method of using the product.

As used herein, the term “veterinary agent” is intended to capture any agent that is used for improving the health and well being of an animal.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### BRIEF DESCRIPTION OF THE DRAWINGS

The invention will now be described by way of example only and with reference to the drawings in which:

FIG. 1 is a flow diagram showing the method of manufacture of a granule fo the present invention.

FIG. 2 is a diagram that shows the adhesion test setup.

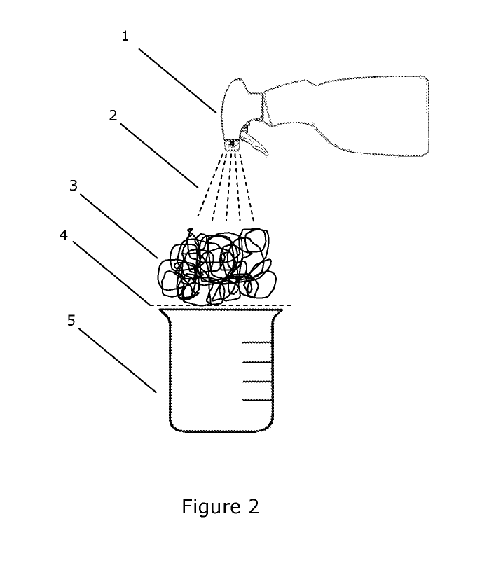

### DETAILED DESCRIPTION OF THE INVENTION

The present invention generally relates a granule comprising one or more veterinary agents. When mixed with an aqueous carrier the granule produces a formulation comprising an effective amount of the one or more veterinary agents and has a viscosity of less than about 250 to about 1,400 cps. The granule produces an aqueous formulation that substantially limits transdermal penetration of the one or more veterinary agents when the formulation is administered topically.

The following non-limiting examples are provided to illustrate the present invention and in no way limit the scope thereof.

### 1. Actives

In one embodiment the formulation includes an active that does not penetrate the skin of the animal to which it is applied. Examples of such actives can be selected from ectoparasiticides and insecticides.

Water-dispersible granules can include hydrophilic and/or hydrophobic active pharmaceutical ingredients. Hydrophillic compounds will aid moisture uptake of the granules during reconstitution and promote granule breakdown, thus resulting in a homogenous drug solution or dispersion. Hydrophobic compounds, such as many of the known ectoparasiticides, have relatively poor solubility in aqueous-based formulations. Consequently, granule breakdown and dispersion of these compounds upon reconstitution is highly challenging. To ensure these hydrophobic compounds form a suitable homogeneous suspension on reconstitution, a range of excipients are included in the formulation, such as surfactants, disintegrants, wetting agents and suspending agents.

The ectoparasiticides and/or insecticide active can be selected from neonicotinoids, phenylpyrazoles, spinosyns, pyrethroids, pyrimidine, triazines, benzamides, macrocyclic lactones, and amidines.

In some embodiments the active includes a neonicotinoid, wherein the neonicotinoid is selected from the group comprising imidacloprid, thiacloprid, dinotefuxan, clothianidin and nitenpyram.

In some embodiments the active includes a phenylpyrazoles, wherein the phenylpyrazoles is selected from fipronil and ethiprole.

In some embodiments the active includes a spinosyns, wherein the spinosyns is selected from spinosad and spinetoram.

In some embodiments the active includes a pyrethroid, wherein the pyrethroid is selected from cypermethrin, deltamethrin.

In some embodiments the active includes a pyrimidine insecticide such as dicyclinil.

In some embodiments the active includes a triazines insecticide such as cyromazine.

In some embodiments the active includes a organophosphorus insecticide such as the diazinon.

In some embodiments the active includes a benzamide insecticide such as diflubenzuron, fluazuron or a combination thereof.

In some embodiments the active includes a amidine insecticide such as amitraz.

In some embodiments the formulation of the present invention comprise a combination of skin-penetrating and non-skin penetrating actives.

phenylpyrazoles is selected from fipronil and ethiprole.

diamide insecticides is selected from rynaxypyr and flubendiamide.

spinosyns is selected from spinosad and spinetoram.

In one embodiment the granule comprises a pyrimidine-derived regulator of insect growth in combination with a second active selected from the group comprising
(i) a spinosyn,
(ii) a neonicotinoid,
(iii) a benzamide,
(iv) a benzoylurea, and
(v) any combination of (i) to (iv).

In one embodiment the granule comprises a pyrimidine-derived regulator of insect growth in combination with a second active selected from the group comprising
(vi) spinosad,
(vii) imidacloprid,
(viii) diflubenzuron,
(ix) triflumuron, and
(x) any combination of (i) to (iv).

In one embodiment the pyrimidine-derived regulator of insect growth is dicyclanil.

In one embodiment the spinosyn is selected from the group comprising spinosad and spinetoram.

In one embodiment the neonicotinoid is selected from the group comprising imidacloprid, thiacloprid, dinotefuxan, clothianidin and nitenpyram.

In one embodiment the benzamide is diflubenzuron.

In one embodiment the benzoylurea is triflumuron.

In one embodiment the granule comprises a triazine in combination with a second active selected from the group comprising
(i) spinosyn,
(ii) a neonicotinoid, and
(iii) a combination of (i) and (ii).

In one embodiment the granule comprises a triazine in combination with a second active selected from the group comprising
(i) spinosad,
(ii) imidacloprid, and
(iii) a combination of (i) and (ii).

In one embodiment the triazine is cyromazine.

In one embodiment the spinosyn is spinosad or spinetoram.

In one embodiment the neonicotinoid is selected from the group comprising imidacloprid, thiacloprid, dinotefuxan, clothianidin and nitenpyram.

In one embodiment the granule comprises a pyrethroid insecticide in combination with a second active selected from the group comprising
(i) a benzamide,
(ii) a macrocyclic lactone,
(iii) an amidine, and
(iv) a combination of (i) and (ii).

In one embodiment the granule comprises a pyrethroid insecticide in combination with a second active selected from the group comprising
(i) diflubenzuron,
(ii) ivermectin,
(iii) amitraz, and
(iv) a combination of (i) and (ii).

In one embodiment the pyrethroid insecticide is cypermethrin. In another embodiment the pyrethroid insecticide is deltamethrin.

In one embodiment the benzamide is diflubenzuron. In another embodiment the benzamide is fluazuron.

In one embodiment the macrocyclic lactone is ivermectin.

In one embodiment the amidine is amitraz.

In one embodiment each active is present at about 0.1, 0.5, 1.0, 5.0, 10, 12.5 15, 17.5, 20, 22.5, 25, 27.5, 30, 32.5, 35, 37.5, 40, 42.5, 45, 47.5, 50, 52.5, 55, 57.5, 60, 62.5, 65, 67.5, 70, 72.5, 75, 77.5, 80, 82.5, 85, 87.5, 90, 92.5, 95, 97.5, 100, 105, 110, 115 or 120 g/L of the formulation, and useful ranges may be selected between any of these values (for example, from about 0.1 to about 10, 0.1 to about 5, about 5 to about 100, about 5 to about 80, about 5 to about 70, about 5 to about 60, about 5 to about 50, about 7.5 to about 100, about 7.5 to about 80, about 7.5 to about 70, about 7.5 to about 60, about 10 to about 100, about 10 to about 90, about 10 to about 80, about 10 to about 70, about 10 to about 60, about 10 to about 50, about 15 to about 100, about 15 to about 90, about 15 to about 80, about 15 to about 70, about 15 to about 60, about 15 to about 50, about 20 to about 100, about 20 to about 90, about 20 to about 80, about 20 to about 70, about 20 to about 60, or about 20 to about 55 g/L of the formulation).

In one embodiment the pyrimidine-derived regulator of insect growth is present at about 1.0, 5.0, 10, 15, 20, 25, 30, 32.5, 35, 37.5, 40, 42.5, 45, 47.5, 50, 52.5, 55, 57.5, 60, 62.5, 65, 67.5, 70, 72.5, 75, 77.5, 80, 85, 90, 95 or 100 g/L of the formulation, and useful ranges may be selected between any of these values (for example, from about 1.0 to about 100, about 10 to about 100, 20 to about 100, about 30 to about 100, about 1.0 to about 80, about 5 to about 80, about 10 to about 80, about 20 to about 80, about 30 to about 80, about 40 to about 80, about 10 to about 70, about 20 to about 70, about 30 to about 70, about 40 to about 70, about 1.0 to about 60, about 10 to about 60, about 15 to about 60, about 20 to about 60, about 30 to about 60, about 40 to about 60, or about 45 to about 55 g/L of the formulation).

In one embodiment the spinosyn is present at about 0.5, 1.0, 2.5, 5.0, 7.5, 10, 12.5, 15, 17.5, 20, 22.5, 25, 27.5, 30, 32.5, 35, 37.5, 40, 45, 50, 55, 60, 65, 70, 75, 80, 85, 90, 95 or 100 g/L of the formulation, and useful ranges may be selected between any of these values (for example, from about 1.0 to about 70, 1.0 to about 50, about 1.0 to about 40, about 1.0 to about 30, about 5.0 to about 60, about 5.0 to about 50, about 5.0 to about 40, about 5.0 to about 30, about 5.0 to about 25, about 10 to about 60, about 10 to about 50, about 10 to about 40, about 10 to about 30, about 10 to about 25, about 15 to about 50, about 15 to about 40, about 15 to about 30, or about 15 to about 25 g/L of the formulation).

In one embodiment the neonicotinoid is present at about 1.0, 5.0, 10, 15, 20, 22.5, 25, 27.5, 30, 32.5, 35, 37.5, 40, 42.5, 45, 47.5, 50, 55, 60, 65, 70, 75, 80, 85, 90, 95 or 100 g/L of the formulation, and useful ranges may be selected between any of these values (for example, from about 1.0 to about 90, 1.0 to about 60, about 1.0 to about 50, about 1.0 to about 40, about 5.0 to about 80, about 5.0 to about 60, about 5.0 to about 50, about 5.0 to about 45, about 5.0 to about 40, about 10 to about 80, about 10 to about 70, about 10 to about 60, about 10 to about 50, about 10 to about 45, about 15 to about 60, about 15 to about 50, about 15 to about 45, or about 15 to about 40 g/L of the formulation).

In one embodiment the benzoyl urea is present at about 0.5, 1.0, 2.5, 5.0, 7.5, 10, 12.5, 15, 17.5, 20, 22.5, 25, 27.5, 30, 32.5, 35, 37.5, 40, 45, 50, 55, 60, 65, 70, 75, 80, 85, 90, 95 or 100 g/L of the formulation, and useful ranges may be selected between any of these values (for example, from about 1.0 to about 70, 1.0 to about 50, about 1.0 to about 40, about 1.0 to about 30, about 5.0 to about 60, about 5.0 to about 50, about 5.0 to about 40, about 5.0 to about 40, about 5.0 to about 30, about 10 to about 60, about 10 to about 50, about 10 to about 45, about 10 to about 40, about 10 to about 30, about 15 to about 50, about 15 to about 40, about 15 to about 35, or about 15 to about 30 g/L of the formulation).

In one embodiment the benzamide is present at about 0.5, 1.0, 2.5, 5.0, 7.5, 10, 12.5, 15, 17.5, 20, 22.5, 25, 27.5, 30, 32.5, 35, 37.5, 40, 45, 50, 55, 60, 65, 70, 75, 80, 85, 90, 95 or 100 g/L of the formulation, and useful ranges may be selected between any of these values (for example, from about 1.0 to about 70, 1.0 to about 50, about 1.0 to about 40, about 1.0 to about 30, about 5.0 to about 60, about 5.0 to about 50, about 5.0 to about 40, about 5.0 to about 40, about 5.0 to about 30, about 10 to about 60, about 10 to about 50, about 10 to about 45, about 10 to about 40, about 10 to about 30, about 15 to about 50, about 15 to about 40, about 15 to about 35, or about 15 to about 30 g/L of the formulation).

In one embodiment the triazine is present at about 1.0, 5.0, 10, 15, 20, 25, 30, 32.5, 35, 37.5, 40, 42.5, 45, 47.5, 50, 52.5, 55, 57.5, 60, 62.5, 65, 67.5, 70, 72.5, 75, 77.5, 80, 85, 90, 95, 100, 105, 110, 115 or 120 g/L of the formulation, and useful ranges may be selected between any of these values (for example, from about 1.0 to about 100, about 10 to about 100, 20 to about 100, about 30 to about 100, about 1.0 to about 80, about 5 to about 80, about 10 to about 80, about 20 to about 80, about 30 to about 80, about 40 to about 80, about 10 to about 70, about 20 to about 70, about 30 to about 70, about 40 to about 70, about 1.0 to about 65, about 10 to about 65, about 15 to about 65, about 20 to about 65, about 30 to about 65, about 40 to about 65, or about 50 to about 65 g/L of the formulation).

In one embodiment the pyrethroid is present at about 0.1, 0.5, 1.0, 5.0, 7.5, 10, 12.5 15, 17.5, 20, 22.5, 25, 27.5, 30, 32.5, 35, 37.5, 40, 42.5, 45, 47.5, 50, 52.5, 55, 57.5, 60, 62.5, 65, 67.5, 70, 72.5, 75, 77.5, 80, 82.5, 85, 87.5, 90, 92.5, 95, 97.5, 100, 105, 110, 115 or 120 g/L of the formulation, and useful ranges may be selected between any of these values (for example, from about 1.0 to about 100, about 1.0 to about 80, about 1.0 to about 650, about 5 to about 100, about 5 to about 80, about 5 to about 70, about 5 to about 65, about 7.5 to about 100, about 7.5 to about 80, about 7.5 to about 70, about 7.5 to about 65, about 10 to about 100, about 10 to about 90, about 10 to about 80, about 10 to about 70, about 10 to about 66, or about 10 to about 60, g/L of the formulation).

In one embodiment the macrocyclic lactone is present at about 0.1, 0.5, 1.0, 5.0, 10, 12.5 15, 17.5, 20, 22.5, 25, 27.5, 30, 32.5, 35, 37.5, 40, 42.5, 45, 47.5, 50, 52.5, 55, 57.5, 60, 62.5, 65, 67.5, 70, 72.5, 75, 77.5, 80, 82.5, 85, 87.5, 90, 92.5, 95, 97.5, 100, 105, 110, 115 or 120 g/L of the formulation, and useful ranges may be selected between any of these values (for example, from about 1.0 to about 100, about 1.0 to about 50, about 5 to about 100, about 5 to about 80, about 5 to about 70, about 5 to about 60, about 5 to about 50, about 7.5 to about 100, about 7.5 to about 80, about 7.5 to about 70, about 7.5 to about 60, about 10 to about 100, about 10 to about 90, about 10 to about 80, about 10 to about 70, about 10 to about 60, about 10 to about 50, about 15 to about 100, about 15 to about 90, about 15 to about 80, about 15 to about 70, about 15 to about 60, about 15 to about 50, about 20 to about 100, about 20 to about 90, about 20 to about 80, about 20 to about 70, about 20 to about 60, or about 20 to about 55 g/L of the formulation).

In one embodiment the amidine is present at about 0.1, 0.5, 1.0, 5.0, 10, 12.5 15, 17.5, 20, 22.5, 25, 27.5, 30, 32.5, 35, 37.5, 40, 42.5, 45, 47.5, 50, 52.5, 55, 57.5, 60, 62.5, 65, 67.5, 70, 72.5, 75, 77.5, 80, 82.5, 85, 87.5, 90, 92.5, 95, 97.5, 100, 105, 110, 115 or 120 g/L of the formulation, and useful ranges may be selected between any of these values (for example, from about 1.0 to about 100, about 1.0 to about 50, about 5 to about 100, about 5 to about 80, about 5 to about 70, about 5 to about 60, about 5 to about 50, about 7.5 to about 100, about 7.5 to about 80, about 7.5 to about 70, about 7.5 to about 60, about 10 to about 100, about 10 to about 90, about 10 to about 80, about 10 to about 70, about 10 to about 60, about 10 to about 50, about 15 to about 100, about 15 to about 90, about 15 to about 80, about 15 to about 70, about 15 to about 60, about 15 to about 50, about 20 to about 100, about 20 to about 90, about 20 to about 80, about 20 to about 70, about 20 to about 60, or about 20 to about 55 g/L of the formulation).

In one embodiment the active is administered at a therapeutic dose of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900 and 5,000 mg/kg of live weight animal and useful ranges may be selected between any of these values (for example, from about 5 to about 300, about 5 to about 150, about 10 to about 150, about 15 to about 125, about 20 to about 125, about 30 to about 100, about 100 to about 1,000, about 150 to about 4,000, about 250 to about 4,000, about 250 to about 3,000, about 250 to about 2,000, about 200 to about 1,000, about 200 to about 900, about 200 to about 850, about 250 to about 850 or about 300 to about 500 mg/kg of live weight animal).

In one embodiment the pyrimidine-derived regulator of insect growth is administered at a therapeutic dose of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, or 1,000 mg/kg of live weight animal and useful ranges may be selected between any of these values (for example, from about 1.0 to about 500, about 5 to about 500, about 10 to about 500, about 15 to about 500, about 20 to about 500, about 25 to about 500, about 30 to about 500, about 1.0 to about 300, about 5 to about 300, about 20 to about 300, about 30 to about 300, about 25 to about 300, about 1.0 to about 200, about 5.0 to about 200, about 10 to about 200, about 20 to about 200, about 25 to about 200, about 30 to about 200, about 1.0 to about 100, about 5.0 to about 100, about 10 to about 100, about 20 to about 100, about 25 to about 100, or about 30 to about 100 mg/kg of live weight animal).

In one embodiment the spinosyn is administered at a therapeutic dose of 50, 75, 100, 125, 150, 175, 200, 225, 250, 275, 300, 325, 350, 375, 400, 425, 450, 500, 550, 600, 650, 700, 750, 800, 850, 900, 950, or 1,000 mg/kg of live weight animal and useful ranges may be selected between any of these values (for example, from about 50 to about 750, about 100 to about 750, about 200 to about 750, about 300 to about 750, about 50 to about 600, about 100 to about 600, about 200 to about 600, about 300 to about 600, about 50 to about 500, about 75 to about 500, about 100 to about 500, about 150 to about 500, about 200 to about 500, about 250 to about 500, or about 300 to about 500 mg/kg of live weight animal).

In one embodiment the neonicotinoid is administered at a therapeutic dose of 50, 75, 100, 125, 150, 175, 200, 225, 250, 270, 275, 280, 290, 300, 325, 350, 375, 400, 425, 450, 500, 550, 600, 650, 700, 750, 800, 850, 900, 950, 1,000, 1,200, 1,400, 1,500, 1,600 1,750, 1,800, 2,000, 2,200, 2,250, 2,400 2,500, 2,600, 2,800, 3,000, 3,200, 3,250, 3,400, 3,500,3,600, 3,750, 3,800 or 4,000 mg/kg of live weight animal and useful ranges may be selected between any of these values (for example, from about 50 to about 4,000, about 100 to about 4,000, about 200 to about 4,000, about 250 to about 4,000, about 280 to about 4,000, about 50 to about 3,500, about 100 to about 3,500, about 200 to about 3,500, about 250 to about 3,500, about 280 to about 3,500, about 50 to about 3,200, about 100 to about 3,200, about 200 to about 3,200, about 250 to about 3,200, or about 280 to about 3,200 mg/kg of live weight animal).

In one embodiment the benzoyl urea is administered at a therapeutic dose of 50, 75, 100, 125, 150, 175, 200, 225, 250, 270, 275, 280, 290, 300, 325, 350, 375, 400, 425, 450, 500, 550, 600, 650, 700, 750, 800, 850, 876, 900, 950, 1,000, 1,200, 1,400, 1,500, 1,600 1,750, 1,800, 2,000 mg/kg of live weight animal and useful ranges may be selected between any of these values (for example, from about 50 to about 2,000, about 100 to about 2,000, about 200 to about 2,000, about 250 to about 2,000, about 50 to about 1,000, about 100 to about 1,000, about 200 to about 1,000, about 250 to about 1,000, about 50 to about 875, about 100 to about 875, about 200 to about 875, or about 250 to about 875 mg/kg of live weight animal).

In one embodiment the benzamide is administered at a therapeutic dose of of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900 and 5,000 mg/kg of live weight animal and useful ranges may be selected between any of these values (for example, from about 5 to about 300, about 5 to about 150, about 10 to about 150, about 15 to about 125, about 20 to about 125, about 30 to about 100, about 100 to about 1,000, about 150 to about 4,000, about 250 to about 4,000, about 250 to about 3,000, about 250 to about 2,000, about 200 to about 1,000, about 200 to about 900, about 200 to about 850, about 250 to about 850 or about 300 to about 500 mg/kg of live weight animal).

In one embodiment the triazine is administered at a therapeutic dose of 50, 100, 150, 200, 250, 300, 350, 400, 450, 500, 550, 600, 650, 700, 750, 800, 850, 900, 950, 1,000, 1,050, 1,100, 1,150 1,200, 1,250, 1,300, 1,350, 1,400, 1,450 1,500, 1,600 1,750, 1,800, 2,000, 2,200, 2,250, 2,400 or 2,500, mg/kg of live weight animal and useful ranges may be selected between any of these values (for example, from about 50 to about 2,500, about 100 to about 2,500, about 500 to about 2,500, about 750 to about 2,500, about 1,000 to about 2,500, about 50 to about 2,500, about 100 to about 2,000, about 500 to about 2,000, about 750 to about 2,000, about 1,000 to about 2,000, about 50 to about 1,500, about 50 to about 1,500, about 100 to about 1,500, about 500 to about 1,500, about 750 to about 1,500, about 1,000 to about 1,500 mg/kg of live weight animal).

In one embodiment the pyrethroid is administered at a therapeutic dose of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900 and 5,000 mg/kg of live weight animal and useful ranges may be selected between any of these values (for example, from about 5 to about 300, about 5 to about 150, about 10 to about 150, about 15 to about 125, about 20 to about 125, about 30 to about 100, about 100 to about 1,000, about 150 to about 4,000, about 250 to about 4,000, about 250 to about 3,000, about 250 to about 2,000, about 200 to about 1,000, about 200 to about 900, about 200 to about 850, about 250 to about 850 or about 300 to about 500 mg/kg of live weight animal).

In one embodiment the macrocyclic lactone is administered at a therapeutic dose of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900 and 5,000 mg/kg of live weight animal and useful ranges may be selected between any of these values (for example, from about 5 to about 300, about 5 to about 150, about 10 to about 150, about 15 to about 125, about 20 to about 125, about 30 to about 100, about 100 to about 1,000, about 150 to about 4,000, about 250 to about 4,000, about 250 to about 3,000, about 250 to about 2,000, about 200 to about 1,000, about 200 to about 900, about 200 to about 850, about 250 to about 850 or about 300 to about 500 mg/kg of live weight animal).

In one embodiment the amidine is administered at a therapeutic dose of 1.0, 5.0, 10, 15, 20, 25, 30, 35, 40, 45, 50, 55, 60, 65, 70, 75, 80, 85, 90, 100, 125, 150, 175, 200, 225, 250, 275, 300, 325, 350, 375, 400, 425, 450, 500, 550, 600, 650, 700, 750, 800, 850, 900, 950, 1,000, 1,100, 1,200, 1,300, 1,400, 1,500, 1,600, 1,700, 1,800, 1,900, 2,000, 2,100, 2,200, 2,300, 2,400, 2,500, 2,600, 2,700, 2,800, 2,900, 3,000, 3,100, 3,200, 3,300, 3,400, 3,500, 3,600, 3,700, 3,800, 3,900, 4,000, 4,100, 4,200, 4,300, 4,400, 4,500, 4,600, 4,700, 4,800, 4,900 and 5,000 mg/kg of live weight animal and useful ranges may be selected between any of these values (for example, from about 5 to about 300, about 5 to about 150, about 10 to about 150, about 15 to about 125, about 20 to about 125, about 30 to about 100, about 100 to about 1,000, about 150 to about 4,000, about 250 to about 4,000, about 250 to about 3,000, about 250 to about 2,000, about 200 to about 1,000, about 200 to about 900, about 200 to about 850, about 250 to about 850 or about 300 to about 500 mg/kg of live weight animal).

### 2. Granule Formulation

As described above the granule formulation comprises one or more beneficial agents. Preferably the beneficial agent is a veterinary active. As used herein, the term “veterinary active” can mean any active that is of benefit to an animal. While including therapeutic actives, this also includes actives such as those that assist in sun protection or assist cosmetically.

As described above in the beneficial agent is present in the granule in a concentration of 0.01, 0.5, 1, 5, 10, 20, 30, 40, 50, 60 or 65% by weight, and useful ranges may be selected between any of these values.

In some embodiments the granule formulation includes a binder. Such binders include water soluble polymers, gums, modified derivatives of starch and cellulose, or combinations thereof. For example, suitable binders include HPMC, ethyl cellulose, gelatin, guar gum, methyl cellulose, povidone, starch, or combinations thereof.

In some embodiments the binder is present in the granule formulation at 0.5, 1.0, 1.5, 2.0, 2.5, 3.0, 3.5, 4.0, 4.5 or 5% by weight, and useful ranges may be selected between any of these values.

The table below sets out the functional excipients for use in the present formulation.

TABLE 1
Functional excipients for use in the present formulation

| Functional | | | Concentration |
|---|---|---|---|
| Excipient | Classification | Examples | Range (%) |
| Beneficial agent(s)* | Single or multiple | Ectoparasiticides, | 0.01-65.0 |
| | | insecticides, insect | |
| | | repellents | |
| Binders (granule | Water soluble | HPMC, Ethyl cellulose, | 0.5-5.0 |
| formers) | polymers, gums, | gelatin, guar gum, | |
| | modified derivatives | methyl cellulose, | |
| | of starch and | povidone, starch | |
| | cellulose | | |
| Solvents (process | Alcohols, glycol | Ethanol, isopropanol, | Volatile solvents |
| aid) | ethers, ketones, | benzyl alcohol, | removed during |
| | esters, glycol ethyl | propylene glycol, | process |
| | esters, aliphatic & | | |
| | aromatic | | |
| | hydrocarbons, | | |
| | chlorinated | | |
| | hydrocarbons | | |
| Wetting agents | Ionic/non-ionic | Pluronics, poloximers, | 0.05-5.0 |
| | surfactants, | polysorbates, gums, | |
| | hydrophilic colloids, | SLS, | |
| | solvents, | | |
| | polyoxyethylene | | |
| | ethers | | |
| Suspending agents | Gums, cellulosic | HPC, HPMC, guar gum, | 0.01-20.0 |
| | material, gelatin, | xanthan gum, | |
| | colloidal silica, | carbomer, | |
| | | carboxymethylcellulose, | |
| | | silicon dioxide | |
| pH modifiers | Acids, alkalis, buffers | HCl, tartaric acid, | 0.01-5.0 |
| | | NaOH, Citric acid, | |
| | | sodium bicarbonate, | |
| | | potassium citrate, | |
| | | sodium citrate | |
| Preservatives | Acids, alcohols, | Benzoic acid, benzyl | 0.001-10.0 |
| (microbiological) | parabens, phenolics, | alcohol, methyl | |
| | glycols, | parabens, propylene | |
| | | glycol | |
| Viscosity modifiers | Gums, cellulosic, | HPMC, silicon dioxide, | 0.01-20.0 |
| | colloidal silica, | xanthan gum, guar | |
| | gelatin, alginates | gum | |
| Fillers/flow | Sugars, cellulosic, | Lactose, | 0.01-90.0 |
| enhancers/ | starch, colloidal silica, | microcrystalline | |
| Absorbing agents/ | stearates | cellulose, magnesium | |
| lubricants | | stearate, silicon dioxide | |
| Anti-foaming agents | Alcohols, stearates, | Polydimethylsiloxanes | 0.01-1.0 |
| | silicones, glycols | | |
| Bio-adhesives | Water soluble film | Polyvinyl pyrolidone | 0.1-10.0 |
| | forming polymers, | (PVP), PVA, chitosan, | |
| | gums, hydrophilic | carbohydrates, sugars, | |
| | polymers, hydrogels, | aligates, cellulosics, | |
| | co-polymers, | polyacrylates, carbopol, | |
| | thiolated polymers | xanthan gum, guar | |
| | | gum | |
| Chemical stabilizers | Anti-oxidants, | EDTA, citric acid, | 0.01-2.0 |
| | chelating agents, | ascorbic acid, | |
| | buffers | tocopherol, BHA | |
| Colouring agents | water soluble dyes | Sunset yellow, | 0.01-1.0 |
| | | carotenoids, | |
| Solubility enhancers | Surfactants, solvents, | PG, PEG, surfactants | 0.1-10.0 |
| | pH modifiers | | |

It should be understood that the term “bioadhesive” includes any veterinarily acceptable film former.

In one embodiment, the granules contain one or more film-forming or bioadheive polymer containing one or more hydrophilic functional groups. Examples of suitable polymers include, (but are not necessarily limited to, polyvinyl alcohol), carboxymethylcellulose (CMC), chitosan, polyvinylpyrrolidone, poly(acrylic acid), HPMC, methyl cellulose, HPC, xanthan, sodium CMC, guar gum and carrageenan or a Gantrez®-type polymer. Gantrez®-type polymers include poly(methylvinylether/maleic acid), esters thereof and similar, related, polymers (e.g. poly(methyl/vinyl ether/maleic anhydride).

In one embodiment the bioadhesive is selected from a carbohydrate, polysaccharide or insect derived polysaccharides. In one embodiment the bioadhesive is chitosan.

In one embodiment the bioadhesive is a plant gum. In various embodiments the bioadhesive may be selected from the group comprising xanthan gum, agar, alginate, cassia, dammar, pectin, beta-glucan, glucomannan, mastic, chicle, psyllium, spruce gum, gellan gum, acacia gum, guar gum, locust bean gum, carrageenans, gum arabic, karaya gum, ghatti gum, tragacanth gum, konjac gum, tara gum, pullulan or a combination of any two or more thereof.

The formulation effectively has three phases.

The first phase is a solid phase (granule). The granule is a dry, stable free flowing homogenous product. It has optimised stability of the active(s) for storage/shelf-life. The granule is readily dispersed in water. A major benefit of the improved stability is the avoidance for the requirement of overage (adding more active to a formulation to account for loss of active).

The second phase is a physically stable dispersed aqueous formulation (solution or suspension). Thixotropic (shear thinning) in nature to optimise product administration/spreadability when applied to animal skin/hair via standard delivery devices (gun type metered dispensers).

The third phase dries on skin to leave a ‘bioadhesive’ film or layer with the potential for a sustained/prolonged therapeutic action.

### 3. Method of Manufacture

In one embodiment the granule is manufactured by spray granulation. This comprises

forming a solids mixture on a fluid bed by mixing a wetting agent and a film former,

spraying a first spray composition comprising a dispersing agent onto the fluid bed and granulating this mixture,

optionally spraying a second spray composition comprising water onto the fluid bed and further granulating this mixture,

thereby providing the granule composition,

wherein at least one beneficial agent can be incorporated as
(v) an at least water soluble beneficial agent mixed with the solids mixture,
(vi) an at least water insoluble beneficial agent mixed with the first spray composition, or
(vii) both i) and ii).

Other excipients can be incorporated into this manufacturing scheme. For example, in some embodiments the solids mixture comprises a filler. In some embodiments the solids mixture comprise an anti-caking agent.

The spray solutions can also comprise various excipients. For example, in some embodiments the first spray mixture comprising an organic solvent as a processing aid.

In some embodiments additional spray mixtures are used. For example, the second spray granulation mixture may comprise water and a buffering agent.

Water may be used as an additional spray granulation mixture.

Once the final spray granulation mixture is sprayed onto the granules forming in the fluid bed, the granules are dried, screened and then packaged. In some embodiments the packaging is to bulk containers.

In one embodiment there is a method of manufacturing a granule composition which comprises
mixing a first composition which comprises at least one beneficial agent that is substantially soluble in water, with a suspending agent and a wetting agent, or
mixing a second composition which comprises at least one beneficial agent that is substantially insoluble in water with an inorganic solvent,
providing the first composition on a fluidised bed,
adding the second composition to the solids on the fluidised bed and granulating said mixture,
thereby providing the granule composition.

In one embodiment the first composition comprises a viscosity modifier. Examples of viscosity modifiers include gums, cellulosic, colloidal silica, gelatin, alginates HPMC, silicon dioxide, xanthan gum, guar gum and combinations thereof.

In one embodiment the first composition comprises a chemical stabiliser. Examples of a chemical stabiliser includes anti-oxidants, chelating agents, buffers, EDTA, citric acid, ascorbic acid, tocopherol, BHA and combinations thereof.

In one embodiment the suspending agent is selection from gums, cellulosic material, gelatin, colloidal silica and combinations thereof.

In one embodiment the first composition comprises a wetting agent. Examples of a wetting agent includes ionic/non-ionic surfactants, hydrophilic colloids, solvents, polyoxyethylene ethers and combinations thereof.

The present invention includes the use of a bioadhedive. The bioadhedive can be incorporated into the granule by being
homogenously mixed throughout the granule in dry form,
sprayed onto the exterior of the granule during granulation, and/or
incorporated into the liquid carrier during reconstitution of the granule.

### 4. Use of the Formulation

An advantage of a granule is its stable storage characteristics. For example, when in a granule form the beneficial agents are able to be stored for a much longer time (than compared to a solution or suspension) without degrading significantly. A granule of the present invention can remain in a stable form for at least 6, 12, 18, 24, 30, or 36 months and useful ranges may be selected between any of these values.

As used herein, the term “stable” means that the beneficial agent has undergone less than 10, 9, 8, 7, 6, 5, 4, 3, 2, 1% degradation, and useful ranges may be selected between any of these values.

When in use, the granule is reconstituted in a diluent, such as water.

In one embodiment about 2, 4, 6, 8, 1,0 1,2 14, 16, 18, or 20 g of granule is reconstituted in 100 mL of diluent, and useful ranges may be selected between any of these values (for example about 2 to about 10, about 2 to about 9, about 2 to about 7, about 2 to about 5, about 2 to about 4, about 3 to about 10, about 3 to about 5, about 4 to about 10, about 4 to about 8, about 4 to about 7, about 5 to about 10, about 5 to about 8, about 5 to about 7, about 6 to about 10, about 6 to about 8, about 7 to about 10, about 7 to about 8 or about 8 to about 10 g per 100 mL of diluent).

In one embodiment the reconstituted aqueous composition comprises 5, 10 15, 20 25, 30, 35, 40 45, or 50% by weight of the granule, and useful ranges may be selected between any of these values (for example, about 5 to about 50, about 5 to about 40, about 5 to about 30, about 5 to about 20, about 10 to about 50, about 10 to about 35, about 10 to about 25, about 15 to about 50, about 15 to about 40, about 15 to about 20, about 20 to about 50, about 20 to about 40, about 20 to about 30, about 320 to about 50, about 30 to about 45, about 30 to about 40 or about 40 to about 50% by weight).

An advantage of the granule of the present invention is its rapid dispersal. In some embodiments the granule disperses within the diluent within 60, 50, 45, 40, 35, 30, 25, 20, 15 or 10 sec, and useful ranges may be selected between any of these values (for example, about 10 to about 60, about 10 to about 50, about 10 to about 40, about 10 to about 30, about 15 to about 60, about 15 to about 45, about 15 to about 40, about 15 to about 30, about 20 to about 60, about 20 to about 40, about 20 to about 35, about 25 to about 60, about 25 to about 50, about 25 to about 40, about 35 to about 60, about 35 to about 40, about 40 to about 60, about 40 to about 50, about 50 to about 60 sec).

Once dispersed, the resultant aqueous formulation is suitable for topically delivery. i.e. application to the skin, hair or wool of an animal (i.e. as a drench).

A particular advantage is that the resultant aqueous formulation comprises the actives in the concentration suitable for exhibiting a therapeutic effect on the target mammal. Particular, if the resultant aqueous formulation comprises two or more beneficial agents, the concentration of each agent relative to each other is suitable for both to be delivered to the target mammal at their individual therapeutic targets.

A further advantage of the present formulation is that the dispersed granule formulation prevents transdermal penetration of the beneficial agents within the granule formulation. This is of particular importance to avoid systemic delivery of beneficial agents that may be toxic systemically.

When applied topically, the aqueous formulation dries to a gel or film on the animal.

The inventors have determined that this gel or film has improved adherence to the skin, resists rain events that would otherwise wash out the actives from the skin, hair or wool of the animal, and retain the beneficial agents in the gel or film, thus preventing their movement across the skin into the systemic circulation.

The resistance of the gel or film to a rain event can be tested using a rain-simulation study. This study is described in detail below.

In one embodiment, use of the granule of the present invention to form an aqueous composition for topical administration results in a gel or film that reduces the loss of the beneficial agent from a rain event. In one embodiment the gel or film results in less than 50, 45, 40, 35, 30, 25, 20, 15, 10% loss of the beneficial agent per 100 mL of water applied over 5-20 min, and useful ranges may be selected between any of these values (for example, about 10 to about 50, about 10 to about 45, about 10 to about 35, about 10 to about 25, about 10 to about 20, about 15 to about 50, about 15 to about 45, about 15 to about 40, about 15 to about 35, about 15 to about 20, about 20 to about 50, about 20 to about 45, about 20 to about 35, about 20 to about 30, about 25 to about 50, about 25 to about 45, about 25 to about 35, about 25 to about 30, about 30 to about 50, about 30 to about 40, about 35 to about 50, about 35 to about 45, about 40 to about 50 or about 45 to about 50% loss of the beneficial agent per 100 mL of water applied over 5-20 min).

In one embodiment the loss of beneficial agent from the film or gel is less than 50, 45, 40, 35, 30, 25, 20, 15, 10 mg of active agent per 100 mL of water following a simulated rain event, and useful ranges may be selected between any of these values (for example, about 10 to about 50, about 10 to about 40, about 10 to about 30, about 10 to about 25, about 10 to about 20, about 15 to about 50, about 15 to about 45, about 15 to about 40, about 15 to about 35, about 15 to about 20, about 20 to about 50, about 20 to about 45, about 20 to about 40, about 20 to about 35, about 20 to about 30, about 25 to about 50, about 25 to about 40, about 25 to about 30, about 30 to about 50, about 30 to about 45, about 30 to about 40, about 35 to about 50, about 35 to about 45 or about 40 to about 50 mg of active agent per 100 mL of water following a simulated rain event).

In one embodiment the drug loss from the film or gel after a simulated rain event is less than 1, 2, 3, 4, 5, 6, 7, 8, 9, 10 mg/mL, and useful ranges may be selected between any of these values (for example, about 1 to about 10, about 1 to about 8, about 1 to about 7, about 1 to about 5, about 2 to about 10, about 2 to about 8, about 2 to about 7, about 2 to about 6, about 2 to about 5, about 2 to about 4, about 3 to about 10, about 3 to about 8, about 3 to about 7, about 3 to about 5, about 4 to about 10, about 4 to about 9, about 4 to about 7, about 4 to about 6, about 5 to about 10, about 5 to about 8, about 5 to about 7, about 6 to about 10, about 6 to about 8, about 6 to about 7, about 7 to about 1,0 7 to about 8, about 8 to about 10 or about 9 to about 10 mg/mL).

As mentioned above, a benefit of the present invention is that it prevents transfer of the active agent across the skin into the systemic circulation. In one embodiment less than 1, 0.9, 0.8, 0.7, 0.6, 0.5, 0.4, 0.3, 0.2 or 0.1% by weight of the active agent permeates transdermally, and useful ranges may be selected between any of these values (for example, 0.1 to about 1, about 0.1 to about 0.9, about 0.1 to about 0.7, about 0.1 to about 0.6, about 0.1 to about 0.5, about 0.1 to about 0.3, about 0.2 to about 1, about 0.2 to about 0.8, about 0.2 to about 0.7, about 0.2 to about 0.5, about 0.2 to about 0.4, about 0.3 to about 0.9, about 0.3 to about 0.8, about 0.3 to about 0.6, about 0.3 to about 0.4, about 0.4 to about 1, about 0.4 to about 0.8, about 0.4 to about 0.7, about 0.4 to about 0.6, about 0.5 to about 1, about 0.5 to about 0.7, about 0.5 to about 0.6, about 0.60 to about 1, about 0.6 to about 0.7, about 0.7 to about 1, about 0.7 to about 0.8, about 0.8 to about 1, about 0.8 to about 0.9% by weight).

### 5. Adhesion Test

An aqueous formulation is prepared. In according with the present invention the aqueous formulation is prepared from a granule.

The testing apparatus comprises a water sprayer 1, that sprays a spray 2 of 1-1.2 mL water per actuation, wool 3, a mesh support 4 and a collecting vessel 5.

10 ml of the granule dispersion is added to 1 g of sheep wool and mixed in a suitably-sized container with a spatula to ensure consistent coverage.

The wool with added formulation is stored at approximately 32° C. degrees overnight to dry.

Once dried the wool is spread out on the centre of a 10 Mesh support screen.

Water was sprayed (1-1.2 mL per actuation) over the surface area of the support screen (314 cm²) at a rate of approximately 20 actuations per minute (using a 1 L bottle equipped with a Canyon Model CHS-3AN chemical resistant trigger).

4 ml samples were removed from the collecting vessel for analysis.

### Examples

### Example 1—Spinosad Granule

This example describes the formation of a granule comprising spinosad as the beneficial agent.

Spinosad is mixed with gum and lactose in a fluidised bed granulator. A spray solution comprising benzyl alcohol and polysorbate 80 is sprayed into the granulator. Once the granule is formed it is mixed with PVP and antifoam in a drum blender.

TABLE 2
Formulation of the granule

| Ingredient | Composition (%) |
|---|---|
| Spinosad | 50.0 |
| Lactose | 18.65 |
| Xanthan Gum | 2.80 |
| Polysorbate 80 | 15.5 |
| PVP (K90) | 5.0 |
| Antifoam AF Emulsion | 0.05 |
| Benzyl alcohol | 2.5 |
| Colloidal silica | 5.5 |

When added to water it was reconstituted 1 part granule to 5 parts water. It was then shaken well to disperse solids and dispensed (metered dose gun).

### Example 2—Triple Granule

Granules were manufactured using a fluid-bed granulation process. The granules contained three actives, of varying aqueous solubility. Abamectin and oxfendazole have relatively low solubility and levamisole hydrochloride is considered to be soluble. The granules were shown to disperse rapidly in water, forming a homogenous dispersion, and have shown to be stable for up to 24 months.

TABLE 3
Formulation of the triple granule

| Component | % by weight | Function |
|---|---|---|
| Abamectin | 0.96 ¹ | Anthelmintic |
| Oxfendazole | 19.66 | Anthelmintic |
| Levamisole hydrochloride | 34.71 | Anthelmintic |
| Cobalt EDTA | 15.19 | Mineral nutrient |
| Sodium selenate | 1.04 | Mineral nutrient |
| Xanthan gum | 1.95 | Thickener |
| Colloidal silicon dioxide | 8.30 | Flow agent |
| Benzyl alchohol | 2.60 | Preservative |
| polysorbate 80 | 13.02 | Surfactant |
| Citric acid anhydrous | 1.30 | Buffer |
| Sodium hydroxide | 0.25 | Buffer |
| Butylated hydroxytoluene | 0.02 | Antioxidant |
| Antifoam AF | 1.00 | Mixing aid |

### Example 3—In Vitro Testing

The purpose of this example was to examine a number of formulations for their effusiveness in being retained on sheep wool after a rain event.

### 1. Method

### 1.1 Test Formulations

The base granule was formed using the components shown below in Table 4.

TABLE 4
Components of the granule used in Example 3.

| Ingredient | Function |
|---|---|
| Spinosad | API |
| Dicyclanil | API |
| Sorbitol | Filler |
| Sodium Lauryl Sulphate | Wetting agent |
| Colloidal Silicon Dioxide | Anti-caking |
| Polysorbate 80 | Dispersing agent |
| Citric acid anhydrous | Buffering agent |
| Sodium Hydroxide | Buffering agent |
| Silicon emulsion | Defoamer |
| Water | Processing aid |
| Benzyl Alcohol | Processing aid |

A variety of different film-formers were incorporated into the base formulation. The different formulations tested are shown below in Table 5.

These examples investigated the incorporation of film-formers within the granule.

### 1.2 Manufacturing Steps

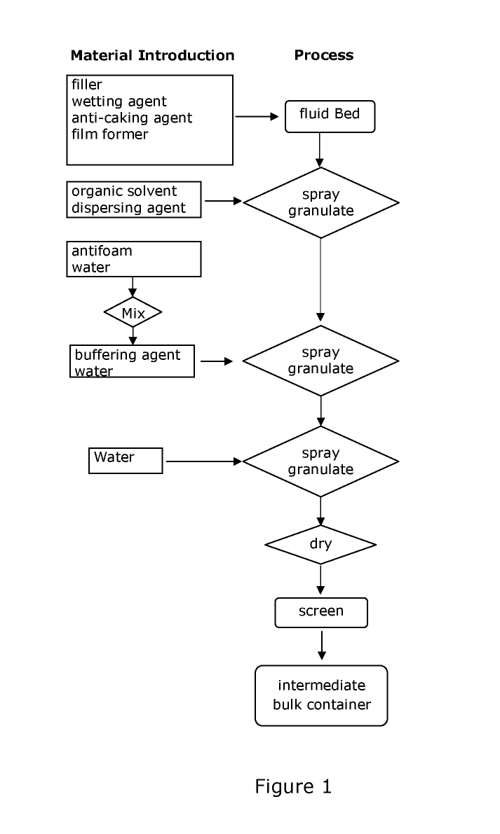

The granules were manufactured using a fluid-bed granulation process at 1.5 kg scale. The granules were reconstituted in an aqueous carrier to a volume of 100 mL. The granulation process flow diagram is shown in FIG. 1. A first mixture of active ingredients, sorbitol, sodium lauryl sulphate, colloidal silicon dioxide, and film-former if relevant, were screened and sifted into the fluid bed. The batch process utilizes a current of air, keeping particles suspended in a fluidized region.

Separately, a second mixture of benzyl alcohol and polysorbate 80 were propeller stirred in a stainless steel vessel and sprayed onto the fluidised powder of the first mixture 1. The fluidized powder is initially sprayed with a polysorbate solution at relatively low air-flow to initiate agglomeration.

A third composition comprising antifoam and water was homogenised and mixed with a fourth composition comprising citric acid and sodium hydroxide which were stirred in a stainless steel vessel. This mixture of the third and fourth mixtures was sprayed onto the fluidised mixture of mixtures 1 and 2, and the air-flow increased the airflow as the particle size of the granules increased.

Water was then spray applied and the resultant granules were dried under a low airflow until the product temperature reached 58° C., resulting in a typical loss on drying of 1-2% by weight.

The resultant granules had the characterisation as shown in Table 6.

TABLE 6
Granule characteristics

| | Film-former | | |
|---|---|---|---|
| Quality Attribute | Xanthan gum | Carbopol | Chitosan |
| Mean Particle Diameter (μm) | 261 | 248 | 310 |
| Loss on Drying (%) | 1.69 | 1.70 | 1.60 |
| Bulk Density (g/cm³) | 0.353 | 0.382 | 0.440 |
| Tapped Density (g/cm³) | 0.405 | 0.434 | 0.460 |
| Carr's Index | 12.9 | 11.8 | 4.3 |
| pH | 5.74 | 4.87 | 6.90 |

### 1.3 Addition of Film-Formers

Xanthan gum or carbopol 971 were used as film-formers and incorporated into the formulation shown in Table 4. Xanthan gum or carbopol 971 was incorporated during manufacture of the granules as a dry mix of powders. That is, the dry ingredients in powdered form were blended prior to granulation. This technique results in the film-former being homogenously dispersed throughout the granule.

Chitosan was used as a film-former and incorporated into the formulation shown in Table 4. Chitosan was incorporated into the granule in liquid form during granulation by spraying. That is, during the granulation process of the ingredients shown in Table 4, chitosan is sprayed into the granulator thereby distributing homogenously throughout the granule.

Kollidon K90 or gantrez S-96 were used as a film former and incorporated into the reconstituted formulation containing the constituents as shown in Table 4. That is, when the granules are reconstituted in the carrier, kollidon K90 or gantrez S-96 were also added. In this manner kollidon K90 and gantrez S-96 dissolved in the reconstituted formulation.

### 1.4 Rain Fall Analysis

Also investigated was the ability of the formulations to retain in wool following rainfall. Rainfall was simulated by the spraying of water on the wool following application of 10 mL of formulation per 1 g of sheep wool. The samples were allowed to dry overnight prior to addition of the water. The water was collected after spraying and analysed for the presence of the actives.

The test formulations were compared to CLIK®, a commercially available suspo-emulsion containing 50 g/L dicyclanil.

### 2. Results

The results are shown in Table 7.

CLIK® is a market-leading commercially available suspo-emulsion that contains 50 g/L dicyclanil. Each of the test formulations were demonstrated to work at least as well as CLIK® in retention of dicyclanil on sheep wool.

Chitosan reconstituted in 1% acetic acid was shown to significantly slow down the API loss during rainfall (P<0.05).

Carbopol was also shown to significantly slow down the API loss during rainfall (P<0.05).

TABLE 7
The amount (mg) of dicyclanil washed off sheep wool during model rainfall (error is SD, N = 3)

| Rain volume | Xanthan | CLIK ® | Chitoson in water | Kollidon | Gantrez | Chitosan in acetic | Carbopol |
|---|---|---|---|---|---|---|---|
| (mL) | (mg) | (mg) | (mg) | (mg) | (mg) | (mg) | (mg) |
| 25 | 12 ± 13 | 61 ± 32 | 41 ± 2.9 | 27 ± 5.8 | 7.6 ± 13 | 15 ± 3.1 | 3.8 ± 1.6 |
| 50 | 63 ± 18 | 90 ± 10 | 76 ± 15 | 59 ± 7.3 | 37 ± 25 | 32 ± 1.3 | 12 ± 1.0 |
| 100 | 103 ± 11 | 112 ± 10 | 99 ± 16 | 89 ± 4.5 | 68 ± 23 | 44 ± 4.9 | 19 ± 3.3 |
| 150 | 124 ± 8.9 | 116 ± 14 | 109 ± 14 | 101 ± 8.8 | 87 ± 16 | 49 ± 6.1 | 25 ± 5.1 |
| 250 | 148 ± 24 | 129 ± 27 | 122 ± 1.4 | 114 ± 5.1 | 99 ± 13 | 56 ± 15* | 33 ± 11* |

1. A granule comprising one or more veterinary agents, a wetting agent, a suspending agent and a bio-adhesive
the granule when mixed with an aqueous carrier producing an aqueous formulation comprising an effective amount of the one or more veterinary agents and having a viscosity of less than about 250 to about 1400 cps,
wherein the aqueous formulation substantially limits transdermal penetration of the one or more veterinary agents when the formulation is administered topically.

2. A granule of claim 1 wherein the aqueous formulation when topically applied to an animal dries to a film or gel substantially limiting the loss of the one or more veterinary agents upon application of water.

3. A granule of claim 1 comprising any one or more of
about 0.01 to about 65% by weight of veterinary agent,
about 0.05 to about 5% by weight of wetting agent,
about 0.01 to about 20% by weight of suspending agent, and
about 0.1 to about 10% of a bio-adhesive.

4. (canceled)

5. (canceled)

6. (canceled)

7. A granule of claim 1 comprising two or more veterinary agents.

8. (canceled)

9. (canceled)

10. A granule of claim 1 wherein the veterinary agent or agents is an ectoparasiticide, and is selected from the group consisting of:
pyrimidines,
triazines,
pyrethroids,
spinosyns,
neonicotinoids,
organophosphates (including organothiophosphates),
benzoylureas,
macrolides, and
amidines.

11. A granule of claim 1 wherein the granule comprises a pyrimidine-derived regulator of insect growth in combination with a second active selected from the group comprising
i) a spinosyn,
ii) a neonicotinoid,
iii) a benzamide,
iv) a benzoylurea, and
v) any combination of (i) to (iv).

12. (canceled)

13. (canceled)

14. A granule of claim 1 wherein the granule comprises a pyrimidine-derived regulator of insect growth in combination with a second active selected from the group comprising
i) spinosad,
ii) imidacloprid,
iii) diflubenzuron,
iv) triflumuron, and
v) any combination of (i) to (iv).

15. A granule of claim 1 wherein the granule comprises a triazine in combination with a second active selected from the group comprising
i) spinosyn,
ii) a neonicotinoid, and
iii) a combination of (i) and (ii).

16. A granule of claim 1 wherein the granule comprises a triazine in combination with a second active selected from the group comprising
i) spinosad,
ii) imidacloprid, and
iii) a combination of (i) and (ii).

17. A granule of claim 1 wherein the granule comprises a pyrethroid insecticide in combination with a second active selected from the group comprising
i) a benzamide,
ii) a macrocyclic lactone,
iii) an amidine, and
iv) a combination of (i) and (ii).

18. A granule of claim 1 wherein the granule comprises a pyrethroid insecticide in combination with a second active selected from the group comprising
i) diflubenzuron,
ii) ivermectin,
iii) amitraz, and
iv) a combination of (i) and (ii).

19. The granule of claim 1, wherein the granule is formulated to provide, when mixed with an aqueous carrier, an aqueous formulation that when administered topically limits transdermal penetration of the one or more veterinary agents, such that less than 1% of the one or more veterinary agents present in the aqueous formulation prior to administration penetrates the dermis.

20. (canceled)

21. The granule of claim 1, wherein the granule is formulated to provide, when mixed with an aqueous carrier, an aqueous formulation that when administered topically to an animal dries to a film or gel, wherein the film or gel substantially limits the loss of the one or more veterinary agents upon application of water such that less than 10% of the one or more veterinary agents present in the aqueous formulation prior to administration is lost.

22. (canceled)

23. (canceled)

24. A method of delivering a beneficial agent or agents to any one of the skin, wool or hair of an animal comprising
providing a granule, each granule comprising the beneficial agent, a wetting agent, a suspending agent and a bio-adhesive,
forming an aqueous composition by suspending or dissolving the granule in an aqueous carrier, the aqueous composition having a viscosity of less than about 250 to about 1,400 cps,
topically administering the aqueous composition to an animal, such that following administration, the aqueous composition dries to a film or gel to
i) substantially limiting the loss of the one or more veterinary agents when exposed to water,
ii) substantially limit transdermal penetration of the one or more veterinary agents, or
iii) both i) and ii).

25. (canceled)

26. (canceled)

27. A method of claim 24 wherein the granule disperses in the aqueous carrier to form an acceptable homogenous formulation within 10 to 60 seconds.

28. A method of claim 24 wherein the formulation on dispersion in the liquid carrier provides a homogeneous liquid formulation.

29. A method of claim 24 wherein the film or gel provides sustained release of the beneficial agent or agents for a period of about 10 to about 100 days.

30. (canceled)

31. (canceled)

32. A method of claim 24 wherein the aqueous composition is thixotropic.

33. (canceled)

34. A method of claim 24 wherein less than about 10 to about 50 mg of the veterinary agent is lost per 100 mL of water if subjected to a simulated rain event.

35. (canceled)

36. A method of manufacturing a granule composition which comprises
mixing a first composition which comprises at least one beneficial agent that is substantially soluble in water, with a suspending agent, or
mixing a second composition which comprises at least one beneficial agent that is substantially insoluble in water with an inorganic solvent, and a wetting agent,
providing the first composition on a fluidised bed,
adding the second composition to the solids on the fluidised bed and granulating said mixture,
thereby providing the granule composition.

37. A method of manufacturing a granule composition which comprises
forming a solids mixture on a fluid bed by mixing a wetting agent and a film former,
spraying a first spray composition comprising a dispersing agent onto the fluid bed and granulating this mixture,
optionally spraying a second spray composition comprising water onto the fluid bed and further granulating this mixture,
thereby providing the granule composition,
wherein at least one beneficial agent can be incorporated as
i) an at least water soluble beneficial agent mixed with the solids mixture,
ii) an at least water insoluble beneficial agent mixed with the first spray composition, or
iii) both i) and ii).
